(19) United States
(12) Patent Application Publication
(10) Pub. No.: US 2012/0285595 A1
(43) Pub. Date: Nov. 15, 2012

(54) FOAM WHEEL ASSEMBLING AND POSITIONING STRUCTURE

(76) Inventor: Chung-Shiu SU, Kaohsiung City (TW)

(21) Appl. No.: 13/107,386

(22) Filed: May 13, 2011

(51) Int. Cl. B60C 7/00

(52) U.S. Cl. 152/310

(57) ABSTRACT

A foam wheel assembling and positioning structure includes a wheel frame having a plurality of ribbed plates thereon and a wheel body covering the ribbed plates. The wheel body has a penetration hole. A first fixing part is formed on a peripheral edge of the penetration hole and provided with a plurality of first fixing holes thereon. Two wheel covers are fixed oppositely on the wheel frame. Each wheel cover has a positioning hole thereon, and a positioning screw penetrates into the positioning hole and is screw-locked with a positioning nut. Furthermore, a peripheral edge of each wheel cover has a second fixing part which has second fixing holes thereon. A fixing element is fixed in the first and second fixing hole, so as to fix the wheel body onto the wheel frame and the wheel covers, thereby avoiding detachment caused by relative sliding during traveling.

### BACKGROUND

1. Field of Invention

The present invention relates to a foam wheel assembling and positioning structure. More particularly, the present invention relates to a structure in which a wheel body is fixed onto a wheel frame and a wheel cover by using a fixing element, so as to avoid detachment caused by relative sliding during traveling and to improve the load.

2. Description of Related Art

Currently, in order to bear a heavier load, general vehicles such as all-terrain vehicles or load carts usually use a foam wheel. The foam wheel structure is formed by covering an outer edge of a wheel frame with a foam wheel body. However, due to the heavy load thereof, during traveling, the foam wheel body will slide relative to the wheel frame and thus may be detached and damaged easily.

Thus, in order to avoid displacement between the wheel frame and the foam wheel body, the Utility Model Patent Application No. 560446, published on Nov. 1, 2003 in Taiwan and entitled “Wheel Frame Structure of Hollow Foam wheel” has disclosed that an inner side edge of a hollow foam wheel body is provided with opposite inner flange parts which form an accommodation space, and two sides of the foam wheel body are provided with two opposite wheel frames whose outer side edges are provided with an outward flange surface. In addition, sharp convex bodies are arranged at an inner side of the outward flange surface, and convex stop parts are convexly arranged on a peripheral surface of a flange end at the inner side of the wheel frame. Stop bodies are circularly arranged in the accommodation space between the two inner flange parts of the foam wheel body. An inner side edge of each stop body is provided with flange parts which can extend below the inner flange part of the foam wheel and is provided with convex stop parts on an outer surface thereof, wherein these convex stop parts just extend between the convex stop parts on the flange ends of the wheel frames in a staggered way. Therefore, when the two opposite wheel frames are fastened and move inwardly, each inner flange part of the foam wheel body is tightly clamped between the flange surface of the wheel frame and the stop body, and the outer side surface of the foam wheel body is positioned through penetration of the sharp convex bodies on the outer flange surface of each wheel frame, so as to enable the hollow foam wheel body to really exert a better elastic buffering effect after being fixed.

As described in the Utility Model Patent Application No. M255139, published on Jan. 11, 2005 in Taiwan and entitled “Improved Enhanced Structure of Hollow Foam wheel”, an interior of a wheel body of a hollow foam wheel is covered with a wheel boss which is provided with a plurality of circularly arranged sections, so as to enable the wheel body to have outward expansion elasticity, and a plurality of sharp parts are arranged uniformly on a concave face of a wheel rim. The circularly arranged sections are placed into the hollow foam wheel body at first, and then the wheel body together with the wheel boss is sleeved on the wheel rim of the wheel frame, so that the sharp parts penetrate into the wheel body to position the wheel body, thereby avoiding sliding between the wheel frame and the wheel body and enabling the foam wheel to bear a heavier load since the interior of the hollow wheel body is covered with the wheel boss.

In the prior patent applications mentioned above, both the wheel frame and the foam wheel body are fixed and joined by using a sharp convex body or a sharp part to achieve an effect of avoiding sliding caused by relative displacement. However, the fixing and joining capability of the sharp convex body or the sharp part is not sufficient, so when traveling at a high speed, the sharp convex body or the sharp part easily breaks off due to an overlarge relative shear force generated between the wheel frame and the foam wheel body. Thus, the using effect is not good.

### SUMMARY

Accordingly, considering that when traveling, a foam wheel in the prior art is easily damaged due to relative sliding, the present invention provides a foam wheel assembling and positioning structure, which includes: a wheel frame provided with a plurality of ribbed plates, wherein through holes are formed between the ribbed plates; a wheel body covering the ribbed plates of the wheel frame, wherein the wheel body is provided with a penetration hole, a first fixing part of the wheel body is formed correspondingly on a peripheral edge of the penetration hole, and the first fixing part is provided with a plurality of first fixing holes thereon; two wheel covers which are fixed oppositely on the wheel frame, wherein each wheel cover is provided with a positioning hole, a positioning screw penetrates into the positioning hole, the positioning screw is screw-locked with a positioning nut, and a peripheral edge of each wheel cover is provided with a second fixing part, on which a plurality of second fixing holes are arranged corresponding to the first fixing holes; and at least one fixing element fixed in the corresponding first and second fixing holes.

The aforementioned fixing element is a bolt and is used for screwing with a fixing nut.

The present invention has the following advantages:

1. The present invention fixes the wheel body onto the wheel frame and the wheel covers by using the fixing element, thereby avoiding detachment and damage caused by relative sliding between the wheel body and the wheel frame or the wheel covers during traveling and further increasing the use life.

2. The present invention can improve the load of the wheel body and thus increase its carrying capacity.

### BRIEF DESCRIPTION OF THE DRAWINGS

FIG. 1 is an exploded perspective view of the present invention;

FIG. 2 is a perspective assembly view of the present invention; and

FIG. 3 is a sectional assembly view of the present invention.

### DETAILED DESCRIPTION

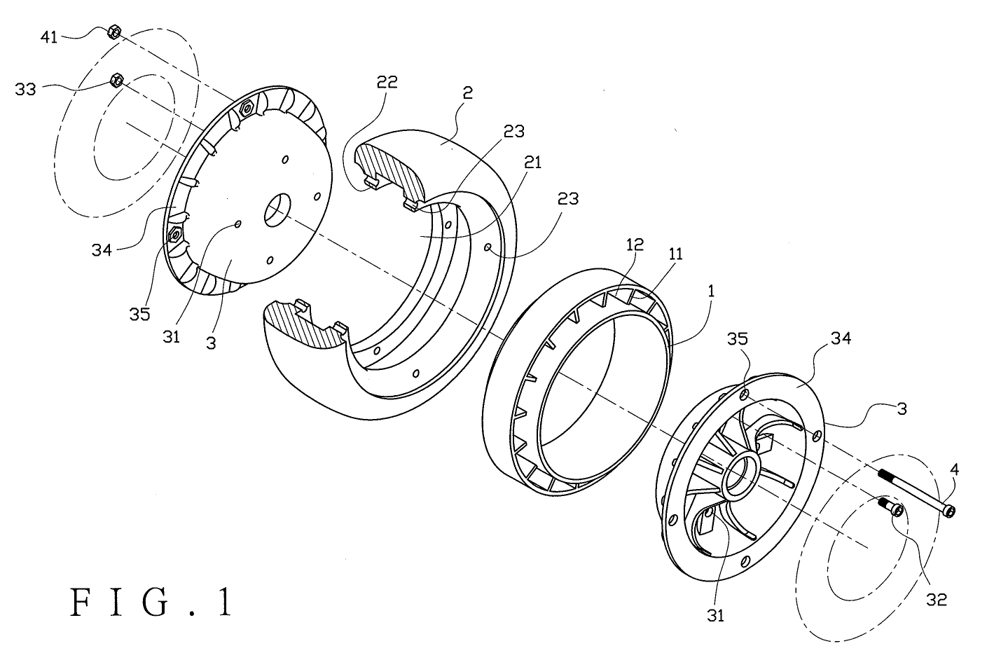

First, referring to FIG. 1, the present invention includes a wheel frame (1), a wheel body (2), two wheel covers (3) and a plurality of fixing elements (4).

A peripheral edge of the wheel frame (1) is provided with a plurality of ribbed plates (11), and through holes (12) are formed between the ribbed plates (11).

The wheel body (2) covers the ribbed plates (11) of the wheel frame (1) and the wheel body (2) is made of a foam material. An inner edge of the wheel body (2) is provided with a penetration hole (21). A first fixing part (22) of the wheel body (2) is correspondingly formed on a peripheral edge of the penetration hole (21). The first fixing part (22) is provided with a plurality of first fixing holes (23) thereon.

The two wheel covers (3) are fixed oppositely on the wheel frame (1) and each wheel cover (3) is provided with a plurality of positioning holes (31). A positioning screw (32) penetrates into each positioning hole (31) correspondingly. The positioning screw (32) is screw-locked with a positioning nut (33), and a peripheral edge of the wheel cover (3) is provided with a second fixing part (34) which is circularly arranged. The second fixing part (34) is provided with a plurality of second fixing holes (35) thereon corresponding to the first fixing holes (23).

The plurality of fixing elements (4) are fixed in the first fixing holes (23) and the second fixing holes (35). Each fixing element (4) is a bolt and is used for screwing with a fixing nut (41).

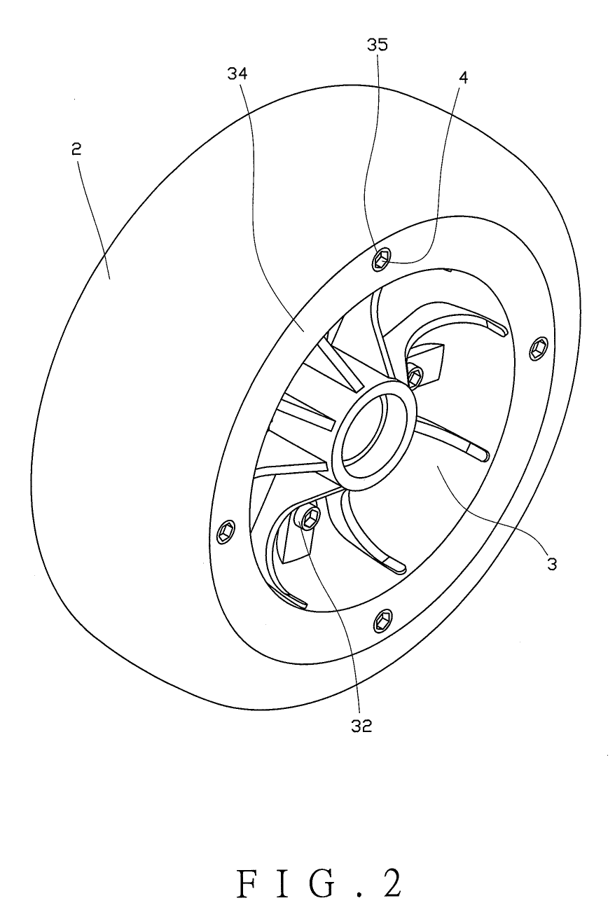

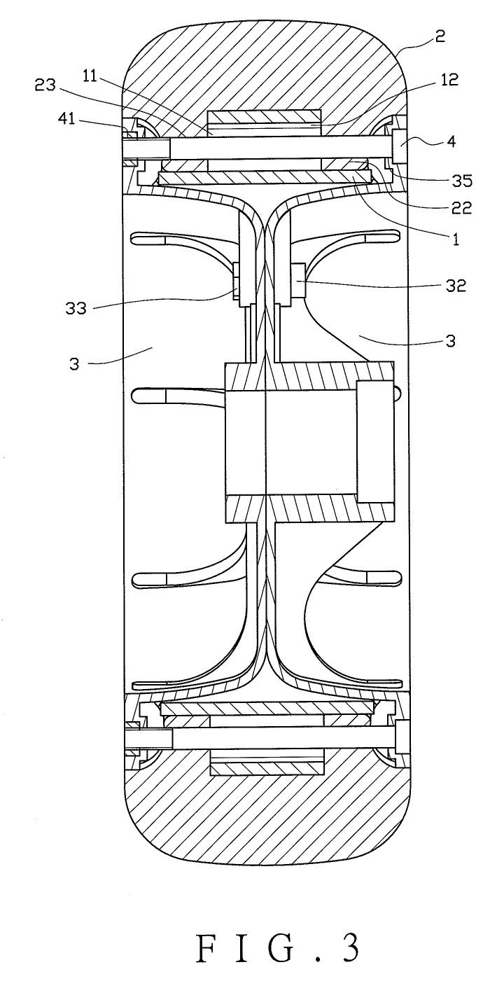

During assembling, as shown in FIGS. 2 and 3, first, the first fixing part (22) of the wheel body (2) covers the ribbed plates (11) of the wheel frame (1). Then, the two wheel covers (3) are clamped at two sides of the wheel frame (1), and the second fixing holes (35) of the two wheel covers (3) are aligned with the first fixing holes (23) of the wheel body (2). Subsequently, the positioning screw (32) is screw-fixed with the positioning nut (33) after passing through the positioning hole (31), so as to fix the two wheel covers (3) at the two sides of the wheel frame (1). Finally, the fixing elements (4) are screw-fixed with the fixing nut (41) after sequentially passing through the second fixing holes (35), the through holes (12) and the first fixing holes (23). Thus, by using the fixing elements (4), the wheel body (2) can be correspondingly fixed with the two wheel covers (3) and the wheel frame (1). When the present invention is installed on a vehicle, during traveling, with a fixing function of the fixing elements (4), rotation of the wheel body (2) will not cause sliding and detachment relative to the wheel frame (1) or the wheel covers (3). Therefore, the wheel body (2) can bear a heavier load and is not easily damaged, and the use life thereof is increased.

However, the aforementioned description is directed only to one of the best embodiments of the present invention and is not intended to limit the claimed scope of the present invention. Any equivalent variations and replacements made according to the claims and the specification of the present invention shall fall within the claimed scope of the present invention.

What is claimed is:

1. A foam wheel assembling and positioning structure, comprising:
a wheel frame provided with a plurality of ribbed plates, wherein through holes are formed between the ribbed plates;
a wheel body covering the ribbed plates of the wheel frame, wherein the wheel body is provided with a penetration hole, a first fixing part of the wheel body is formed correspondingly on a peripheral edge of the penetration hole, and the first fixing part is provided with a plurality of first fixing holes thereon;
two wheel covers fixed oppositely on the wheel frame, wherein each wheel cover is provided with a positioning hole, a positioning screw penetrates into the positioning hole, and the positioning screw is screw-locked with a positioning nut, and a peripheral edge of each wheel cover is provided with a second fixing part which is provided with a plurality of second fixing holes thereon corresponding to the first fixing holes; and
at least one fixing element fixed in the corresponding first and second fixing holes.

2. The foam wheel assembling and positioning structure of claim 1, wherein the fixing element is a bolt and is used for screwing with a fixing nut.
